(19) United States
(12) Patent Application Publication
(10) Pub. No.: US 2011/0010260 A1
(43) Pub. Date: Jan. 13, 2011

(54) Incentive System And Method For Network-Based Purchases

(75) Inventors: Scott Fetters, San Diego, CA (US); Alex Rolek, San Diego, CA (US); Justen Palmer, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(73) Assignee: WEBCELEB, INC., San Diego, CA (US)

(21) Appl. No.: 12/834,785

(22) Filed: Jul. 12, 2010

Related U.S. Application Data
(60) Provisional application No. 61/224,759, filed on Jul. 10, 2009.

(51) Int. Cl. G06Q 30/00

(52) U.S. Cl. 705/26.1

(57) ABSTRACT

An incentive system and method for network-based purchases or sales is disclosed. A number of slices of revenue is defined and associated with an initial product purchase, executed over a network by a product vending system. The slices include a creator slice of the revenue associated with a creator of the product, and one or more purchaser slices associated with respective one or more purchasers of the product. For subsequent product purchases, a profit related to each subsequent product purchase is calculated. For each subsequent product purchase, the profit to the creator and to the one or more purchasers is apportioned based on their respective associated creator slice and one or more purchaser slices.

### CROSS REFERENCE TO RELATED APPLICATIONS

This application claims the benefit of priority under 35 U.S.C. §119 to U.S. Provisional Patent Application Ser. No. 61/224,759, filed on Jul. 10, 2009, entitled, “INCENTIVE SYSTEM AND METHOD FOR NETWORK-BASED PURCHASES”, the entire disclosure of which is incorporated by reference herein.

### BACKGROUND

This disclosure relates generally to electronic commerce, and more particularly to a system and method to incentivize purchases of products through an electronic commerce network or platform.

### SUMMARY

In general, this document discusses a system and method for incentivizing purchasers with a portion, or “slice,” of a product's creator's future revenue based on sales of that product. A slice corresponds to, or defines, a right to a dividend distributed on future purchases of a product, whereas the value of such dividend is split evenly among all current slices. A computer system processes transactions, disperses dividends, and manages the slices. The system is connected to an applicable product vending system, such as a web-based store or other on-line electronic commerce platform. A portion of the revenue from products purchased on the system benefits previous purchasers of those products, and accordingly, this feature incentivizes purchasers to market the products to their networks of other potential purchases.

In one aspect, a system is disclosed. The system includes a product vending system that executes an initial product purchase or sale over a communications network by one or more purchasers of a product. The product is associated with a creator, which can be an individual, a group of individuals, or a commercial entity. The system further includes a secure slices server, in communication with the product vending system, and configured to define a number of slices of revenue associated with the initial product purchase. The number of slices includes a creator slice of the revenue associated with the creator of the product and one or more purchaser slices associated with the one or more purchasers of the product. The secure slices server is further configured, for subsequent product purchases, to calculate a profit related to each subsequent product purchase, and to apportion the profit to the creator and to the one or more purchasers based on their respective associated creator slice and one or more purchaser slices.

In another aspect, a method is disclosed. The method includes the steps of defining a number of slices of revenue associated with an initial product purchase executed over a network by product vending system, the number of slices comprising a creator slice of the revenue associated with a creator of the product, and one or more purchaser slices associated with respective one or more purchasers of the product. For subsequent product purchases, a profit related to each subsequent product purchase is calculated. The method further includes apportioning, for each subsequent product purchase, the profit to the creator and to the one or more purchasers based on their respective associated creator slice and one or more purchaser slices.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of an incentive system.

FIG. 2 is a flowchart of an incentive method.

Like reference symbols in the various drawings indicate like elements.

### DETAILED DESCRIPTION

This document describes a system and method to incentivize consumers to purchase products, by automatically determining and providing purchasers with a portion, or “slice,” of future revenues derived from future purchases of a product. A slice is automatically calculated by a computer, based on a purchaser's purchasing behavior associated with the system, to define a right to a dividend distributed on future purchases of a product, whereas the value of such dividend is split evenly among all current slices.

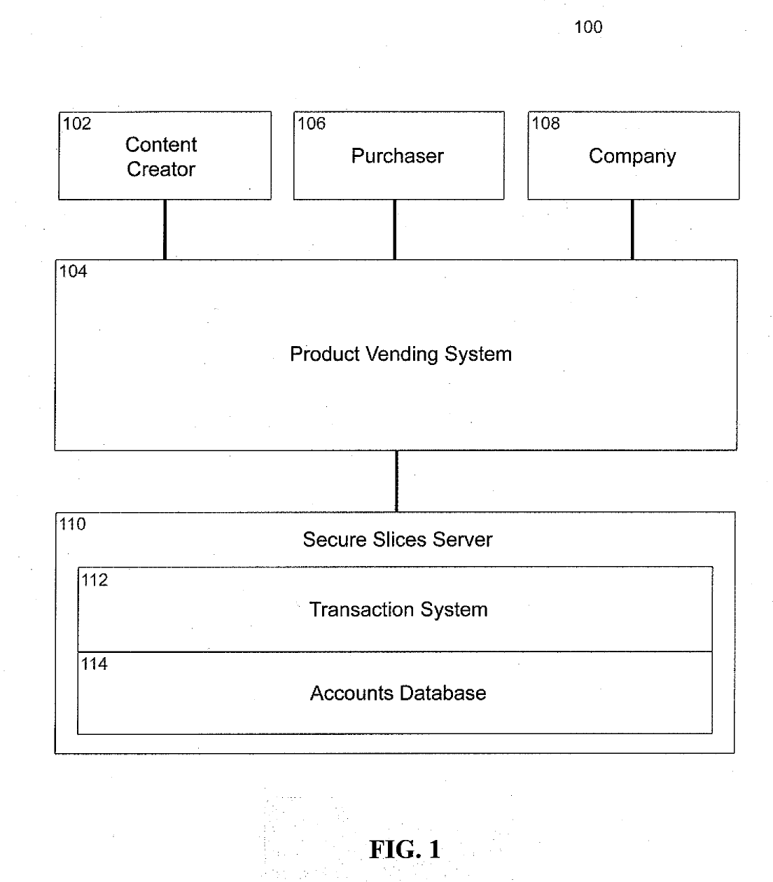

FIG. 1 is a block diagram of an incentive system 100 in accordance with some preferred implementations. A content creator 102 is an individual or group that owns the rights to vend a product. The product can be tangible, such as a good or a device, or the product can be intangible, such as digital data representing a song, an image or a video. Intangible products can become tangible once recorded on a tangible medium and executed or played by a digital data processor. Content creators 102 use a product vending system 104 to sell their product. A purchaser 106 is an individual or group that can purchase a product via interaction with the product vending system 104.

A company 108 hosts a secure slices server 110 and receives a portion of revenue from each transaction made on the incentive system 100 or product vending system 104. The secure slices server 110 is preferably integrated with the product vending system 104, through, at least but not limited to, a data communications network. In some implementations, the product vending system 104 and the secure slices server 110 are integrated in software and hosted on the same server or distributed server system.

In preferred implementations, the product vending system 104 interacts with users through the use of a graphical user interface (GUI). The GUI can be generated by a server associated with the incentive system 100, or by a local application that is resident on a client computer, such as a desktop computer, laptop computer, or handheld computing device (such as a smart phone or other mobile computing device). The GUI is generated by an application to display products for purchase, which application further enables users to browse and select products to purchase via the GUI.

The secure slices server 110 includes a transaction system 112 and an accounts database 114. The product vending system 104 communicates with the transaction system 112 within the secure slices server 110 to process purchases, and to request account related information to display to the user. The transaction system 112 handles all product purchases and manages all transaction information. For each product purchase, the transaction system 112 verifies the purchase, disperses revenue to the appropriate parties, distributes slices to the purchaser, and processes the product for delivery. The transaction system is also responsible for reporting account information to the vending system and expiring slices after a determined period of time. The accounts database 114 stores all money, purchase, and slices information. The following is one of the possible implementations for the accounts database 114:

Accounts Table

| | |
|---|---|
| Id | integer |
| User_id | integer |
| Dollars | double |
| State | binary |

Purchases Table

| | |
|---|---|
| Seller_id | integer |
| Buyer_id | integer |
| Amount | double |
| Time_stamp | datetime |
| Product | varchar |
| Product_id | integer |

Slices

| | |
|---|---|
| User_id | integer |
| Content_str | varchar |
| Content_id | integer |
| Owner_id | integer |
| Time_stamp | datetime |
| State | binary |
| Profit | double |

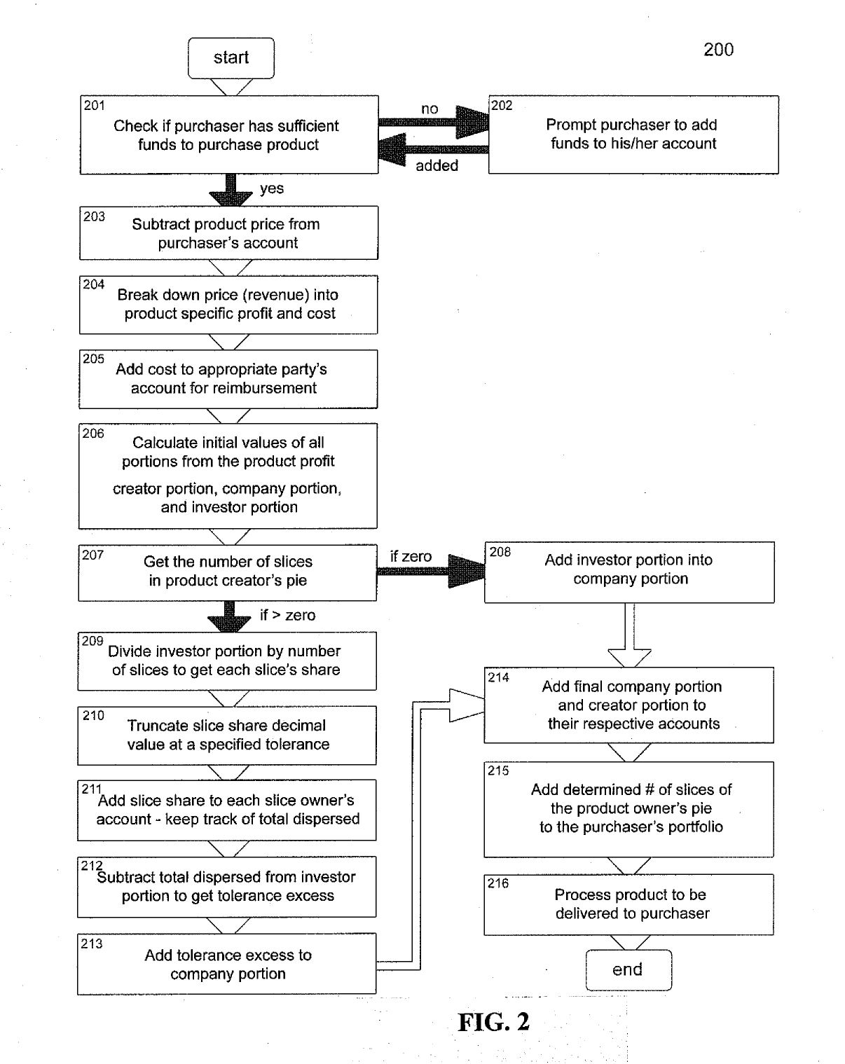

FIG. 2 is a flowchart illustrating an incentive method and process flow 200 of an incentive system. At 201 the system checks whether a purchaser has a sufficient account balance to purchase a selected product. An account balance is selected from the accounts table in the database. A price is specific to the product purchased. The balance is sufficient if it is greater than the product price. If the balance is greater than the purchase price, the flow 200 continues to 203, else continues to 202. At 202, if purchaser's balance is not sufficient, the purchaser is prompted with a form to add funds to their account. At 203, if balance is sufficient, the product price is subtracted from purchaser's account, and is represented as revenue for the remainder of the process flow 200.

At 204, revenue is broken down into profit and cost according to which product was purchased. At 205, the cost is distributed to the accounts of the parties responsible for producing and delivering the product. For example, if the product is a digital music file, such products have no “costs” from the perspective of the product vending system, and no money is distributed. However, if the product is a poster, the cost is divided between the printing, packaging and delivery companies.

At 206, initial portions of the profit are calculated for the owner, investor, and company. Owner and investor portions are calculated by multiplying their respective portion by profit. The company portion is what remains of the profit after the owner and investor portions are removed. An example calculation by the system follows:

Ex: Given creator factor=0.5 and investor factor=0.4 and profit=$1

creator portion=creator factor*profit=0.5*$1=$0.50

investor portion=investor factor*profit=0.4*$1=$0.40

company portion=profit−creator portion−investor portion=$1−$0.40−$0.50=$0.10

At 207 the database is queried for the total number of active slices in the product creator's “pie,” or total portion. For example, the system may find that there are currently three slices in the creator's pie; these slices are owned by the previous purchaser of the creator's products. If there are no slices returned, the process flow continues to 208, else it routes to 209. If the number of slices is zero, at 208 the company portion is set as the sum of the initial investor and company portions, and the process flow continues to 214. For example, if there are no slices in the creator's pie, the investor portion are given to the company.

If number of slices is greater than zero, at 209 the investor portion is divided by the number of slices to determine each slice's share of profit.

Ex. Given investor portion=$0.40 and number of slices=3

slice share=investor portion/number of slices=$0.40/3=$0.13333333333333

At 210, the decimal value of each slice share is cut off at a length given by tolerance. At 211 the slice share is added to each slice owner's account, and the funds to be dispersed is calculated. At 212, the total dispersed is subtracted from the investor portion to derive the tolerance excess, which is added to the company portion to derive an adjusted company portion, at 213. At 214, the adjusted company portion and creator portion are distributed to their respective accounts.

At 215 slices are added to the product purchaser's portfolio. Each added slice represents a portion of the future revenue from the product for the product creator. A number of slices that are granted for each purchase is defined by the product. Once the number of slices is determined, a record of each of these slices is stored in the database. For example, if a digital song that is purchased has a profit of $1.00, rounding down to the nearest integer yields one. The system then will add one new slice to the portfolio of the song purchaser. This slice will entitle the purchaser to a portion of the future revenue of the song creator based on future purchases of the digital song. At 216, after all revenue has been properly distributed, the system executes delivery of the product to the purchaser, either through digital communication channels or normal commercial delivery channels.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A system comprising:
a product vending system that executes an initial product purchase over a communications network by one or more purchasers of a product, the product being associated with a creator; and
a secure slices server, in communication with the product vending system, and configured to define a plurality of slices of revenue associated with the initial product purchase, the plurality of slices comprising a creator slice of the revenue associated with the creator of the product and one or more purchaser slices associated with the one or more purchasers of the product, the secure slices server further being configured, for subsequent product purchases, to calculate a profit related to each subsequent product purchase, and to apportion the profit to the creator and to the one or more purchasers based on their respective associated creator slice and one or more purchaser slices.

2. The system in accordance with claim 1, wherein the product is a digital music file.

3. The system in accordance with claim 1, wherein the secure slices server is configured to calculate a cost for the product for each subsequent product purchase.

4. The system in accordance with claim 3, wherein the profit related to each subsequent product purchase includes the cost for the product.

5. The system in accordance with claim 1, wherein the product vending system includes a memory storing a vending program, and one or more processors to execute the vending program to execute the initial and subsequent product purchases.

6. A method comprising:
defining a plurality of slices of revenue associated with an initial product purchase executed over a network by product vending system, the plurality of slices comprising a creator slice of the revenue associated with a creator of the product, and one or more purchaser slices associated with respective one or more purchasers of the product;
for subsequent product purchases, calculating a profit related to each subsequent product purchase; and
apportioning, for each subsequent product purchase, the profit to the creator and to the one or more purchasers based on their respective associated creator slice and one or more purchaser slices.

7. The method in accordance with claim 6, wherein the product is a digital music file.

8. The method in accordance with claim 6, further comprising calculating a cost for the product for each subsequent product purchase.

9. The method in accordance with claim 8, wherein the profit related to each subsequent product purchase includes the cost for the product.

10. The method in accordance with claim 1, wherein the product vending system includes a memory storing a vending program, and one or more processors to execute the vending program to execute the initial and subsequent product purchases over the network.
